(19) United States
(12) Patent Application Publication
(10) Pub. No.: US 2026/0129328 A1
(43) Pub. Date: May 7, 2026

(54) In-Ear Headphone with Ear Cuff

(71) Applicant: Bose Corporation, Framingham, MA (US)

(72) Inventors: Zachary David Provost, Marlborough, MA (US); Kenneth Gagnon, Leominster, MA (US); Allen Timothy Graff, Sutton, MA (US); Richard Lionel Lanoue, III, Whitinsville, MA (US); Joel Henry Miller, Westborough, MA (US)

(21) Appl. No.: 18/935,839

(22) Filed: Nov. 4, 2024

(51) Int. Cl. H04R 1/10; H04R 1/06; H04R 25/00

(52) U.S. Cl. CPC H04R 1/1016; H04R 1/06; H04R 1/105; H04R 1/1083; H04R 25/609; H04R 25/652; H04R 2460/01; H04R 2460/09

(57) ABSTRACT

Aspects include headphones. In certain cases, a headphone includes: an ear cuff body having: a first portion configured to pass over an outer side of at least one of an antihelix, a helix, or a lobule of a user's outer ear; and a second portion configured to sit behind the outer ear; an acoustic package configured to deliver sound to the ear canal region; and wiring extending between the ear cuff body to the acoustic package.

### BACKGROUND

The disclosure relates generally to wearable audio devices. More particularly, the disclosure relates to headphones such as in-ear headphones.

### SUMMARY

Various implementations are directed to headphones. In certain cases, a headphone includes an ear cuff and an acoustic package configured to deliver sound to the ear canal region.

In particular cases, a headphone includes: an ear cuff body having: a first portion configured to pass over an outer side of at least one of an antihelix, a helix, or a lobule of a user's outer ear; and a second portion configured to sit behind the outer ear; an acoustic package configured to deliver sound to the ear canal region; and wiring extending between the ear cuff body to the acoustic package.

All examples and features mentioned below can be combined in any technically possible way.

In certain cases, the acoustic package is housed in an ear tip.

In some cases, the ear tip provides an acoustic seal on the ear canal during use.

In certain cases, the ear tip is non-occluding during use.

In some aspects, the ear tip is one of a plurality of ear tips of distinct size configured to accommodate distinct ear fits for the acoustic package.

In particular aspects, the acoustic package comprises a driver having a diameter less than approximately 10 millimeters (mm), and in more particular cases, a diameter less than approximately 5 mm. In certain examples, a hearing aid can have a driver with a diameter of approximately 5 mm or less. In other examples, an earbud can have a driver with a diameter of approximately 10 mm or less.

In certain cases, the wiring is housed in a sleeve.

In some cases, the sleeve is deformable to tailor a fit of the acoustic package in the user's ear.

In particular aspects, the sleeve includes a thermoformed material.

In some cases, the wiring has an adjustable length to accommodate different fits. In particular cases, the adjustable length is configured to accommodate different ear dimensions, such as a distance from the user's ear canal to the antihelix or helix.

In particular cases, the wiring is at least partially housed in the ear cuff body.

In some examples, the ear cuff body includes a service loop for storing a portion of the wiring.

In some cases, the headphone further includes at least one wire guide coupled with the ear cuff body. In some cases, the wire guide includes a wire management component for controlling an effective distance between the ear cuff and the acoustic module and/or for retaining a portion of the wire.

In certain aspects, the wiring is modularly coupled with the acoustic module.

In certain aspects, the wiring is modularly coupled with the ear cuff body such that distinct lengths of wiring can be coupled and decoupled with the ear cuff body to accommodate distinct fits.

In particular cases, the wiring includes a structural element providing a force on the acoustic package to retain the acoustic package in the ear canal region.

In some aspects, the structural element includes a protrusion for contacting a portion of the user's ear. In some examples, the protrusion includes a wing, a pillar, a bump, etc.

In certain cases, the structural element includes a thickened section of a sleeve around a portion of the wiring.

In some aspects, the headphone further includes a driver for delivering the sound via the acoustic package, wherein the driver is located in the ear cuff body or in the acoustic package.

In some cases, the headphone further includes at least one microphone located in the ear cuff body and/or the acoustic package.

In certain cases, the at least one microphone comprises at least two microphones at distinct locations on the headphone.

In particular aspects, a feedforward microphone is located on the ear cuff body.

In some cases, at least one of the antihelix, the helix, or the lobule of the ear is configured to be located between the first portion of the ear cuff body and the second portion of the ear cuff body.

In certain aspects, the ear cuff body is generally “C”-shaped.

In some cases, the headphone further includes a battery module contained in the ear cuff body.

In particular cases, the battery module is housed in the second portion of the body.

In some aspects, the acoustic package defines an earbud.

In some cases, a hearing aid includes the headphone.

In particular aspects, a receiver-in-canal (RIC) hearing aid includes the hearing aid. In some aspects, the acoustic package is configured to seal an entrance to the user's ear canal.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example headphone according to various implementations.

FIG. 2 depicts a close-up of the headphone of FIG. 1 on a user's ear.

FIG. 3 depicts the headphone of FIGS. 1 and 2 on a user's ear.

FIG. 4 is a perspective view of an example headphone according to various implementations.

FIG. 5 is a perspective view of an example headphone according to various implementations.

FIG. 6 is a partial cut-away view of an example headphone according to various implementations.

FIGS. 7-9 illustrate perspective views of an example headphone according to various implementations.

FIGS. 10-14 illustrate features of wiring length adjustment in headphones according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include an in-ear headphone having an ear cuff that passes over the outer side of the antihelix, helix and/or lobule of a user's ear. In particular cases, relative to conventional in-ear headphones the disclosed in-ear headphone having an ear cuff enables enhanced comfort, retention, and/or acoustic performance. In some examples, the use of an in-ear portion with an ear cuff allows for distribution of the headphone's weight across distinct areas of the ear, enhancing comfort. In further examples, the ear cuff acts to stabilize the in-ear portion of the headphone to improve fit, retention, and/or acoustic performance. In still further examples, such as where the headphone includes a hearing aid, the ear cuff form factor may provide a more visually appealing design to users. The ear cuff can be customized and/or decorated in various implementations to provide visual benefits comparable to jewelry. Further, relative to conventional open-ear headphones, the disclosed headphones can beneficially deliver sound to the user's ear canal region, improving audio quality, and/or mitigating detection of environmental noise. In particular examples, the in-ear portion of the headphone can be configured to acoustically seal the user's ear canal region.

These implementations may reduce manufacturing costs and/or complexity relative to conventional headphone headbands, among other benefits.

Commonly labeled components in the FIGURES are considered to be substantially equivalent components for the purposes of illustration, and redundant discussion of those components is omitted for clarity.

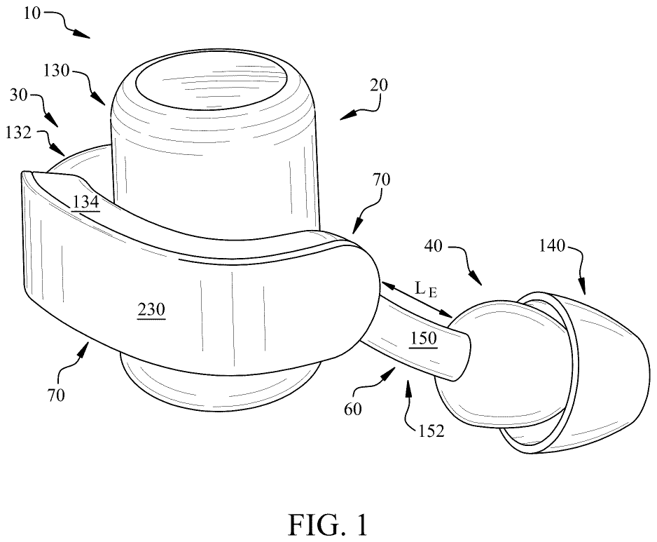

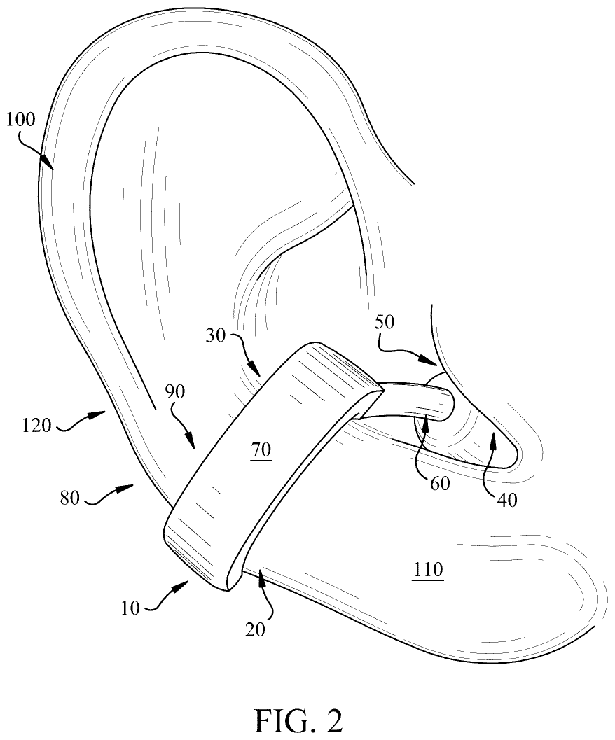

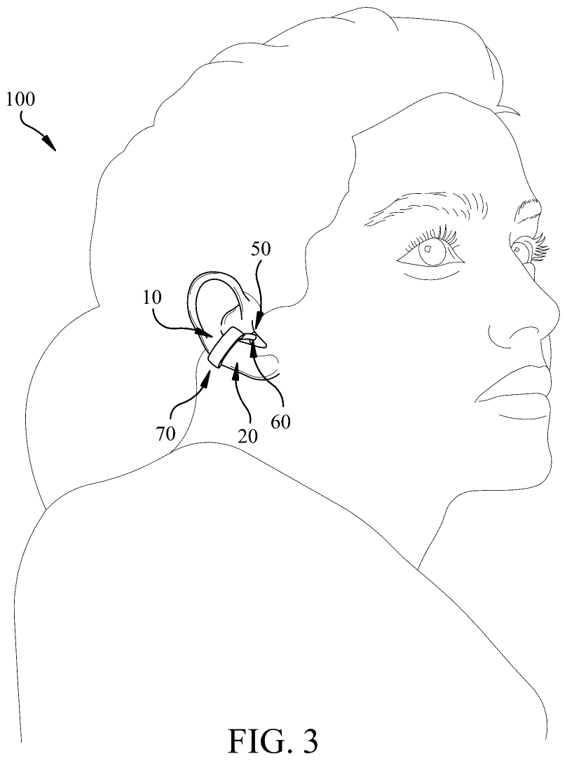

FIG. 1 shows a perspective view of a headphone 10 according to various implementations. FIG. 2 shows a close-up perspective of the headphone 10 according to example implementations on a user's ear. FIG. 3 shows an additional perspective of the headphone 10 of FIGS. 1 and 2 on a user's ear. FIGS. 1-3 are referred to collectively.

In certain cases, the headphone 10 includes an on-ear headphone that is configured to fit on a portion of a user's ear during wear. In certain cases, the headphone 10 includes at least one transducer (e.g., an electro-acoustic transducer) for providing an audio output, and in additional cases, at least one microphone. The headphone 10 can house various additional electronics as described herein. Further, electronics can be stored in various portions (or sections) of the headphone 10 depending on device configuration, usage, etc. In any case, the headphone 10 can be configured to mount on the user's ear and deliver an acoustic output to the region proximate the user's ear canal (e.g., ear canal entrance).

In particular cases, the headphone 10 includes an ear cuff portion 20 that includes a body (or simply, ear cuff body) 30, an acoustic package 40 configured to deliver sound to the ear canal region 50, and wiring 60 extending between the ear cuff body 30 and the acoustic package 40. In certain cases, the ear cuff body 30 has a first portion 70 configured to pass over an outer side 80 of at least one of the antihelix 90, the helix 100, or the lobule 110 of the user's outer ear 120. The ear cuff body 30 also has a second portion 130 configured to sit behind the outer ear 120. In an example, the first portion 70 is generally “L” shaped and the ear cuff body 30 together (i.e., the first portion 70 and second portion 130) is generally “C” shaped. In some cases, first portion 70 and second portion 130 are connected by portion 132 (FIG. 1) that is configured to pass over the edge of the outer ear 120.

In certain examples, to add compliance to first portion 70 such that it sits on the uneven surface of concavity, there may be a cushion or other compliant or compressible member 134 (FIG. 1) on all or part of first portion 70, or first portion 70 can be made from a compliant material such as a foam. If light clamping of the headphone 10 to the ear is desirable, compliance can be built in. For example, at least first portion 70 could be made of an elastomer or include a hinge element so that it can flex, thus altering the location of second portion 130 and altering the thickness of the gap between portions 70 and 130 that encompass ear portion. A suitable compliant elastomer may have a hardness of 80 durometer shore A, in one non-limiting example.

Generally, the outer ear (also known as the auricle or pinna) of a human includes a concha that is immediately adjacent to the entrance to the ear canal, which is underneath (or, behind) the tragus. The concha is divided by the helix crus into a lower portion termed the cavum conchae and an upper portion termed the cymba conchae. The cavum conchae is a generally bowl-shaped feature that is directly adjacent to the ear canal. The cavum conchae typically includes a depression bordered by the anti-tragus, which is the lower part of the anti-helix and/or bordered by the lobule. The lobule (i.e., the earlobe), which is at the lower end of the helix, is typically just below the anti-tragus. Additional description of ear anatomy is included, for example, in U.S. Pat. No. 11,140,469 (Open-Ear Headphone, issued Oct. 5, 2021), the entire contents of which are incorporated by reference.

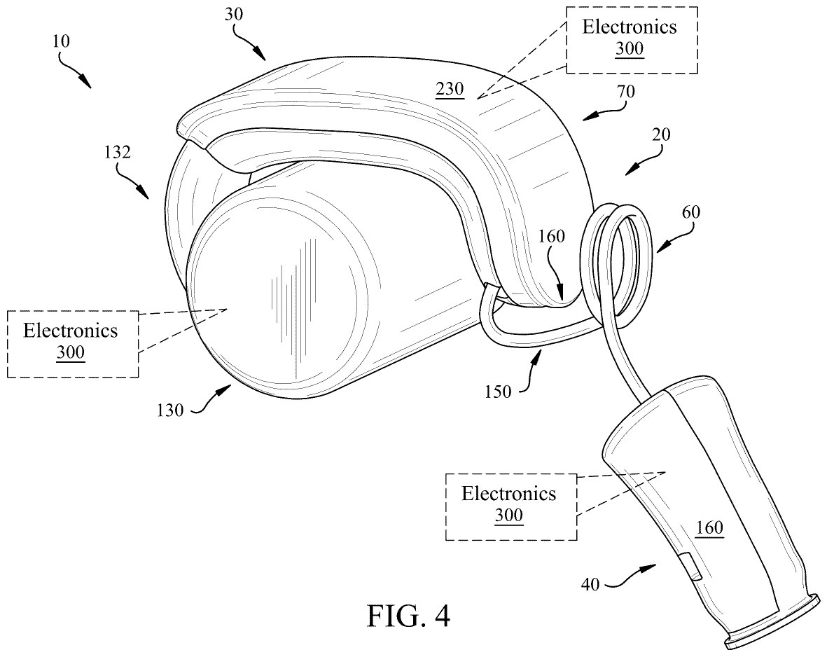

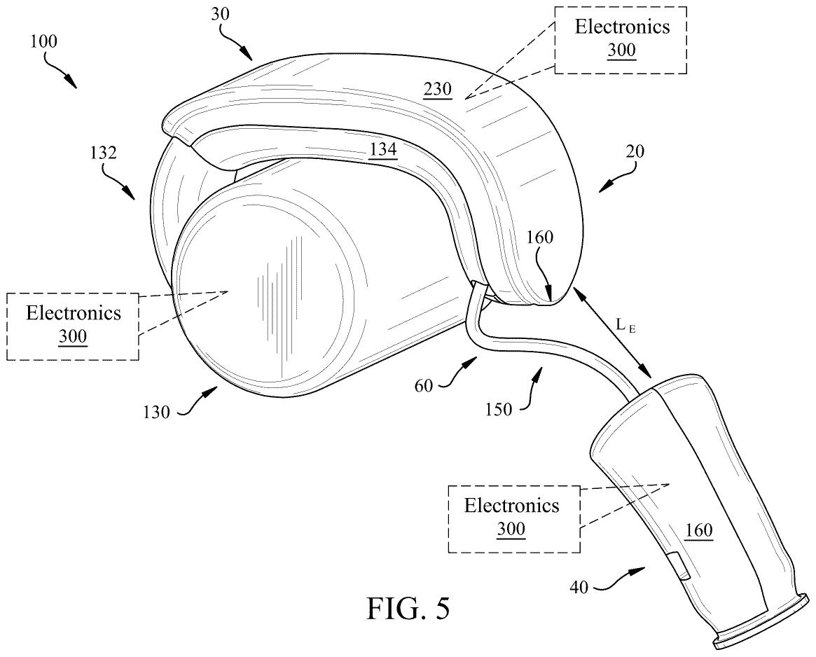

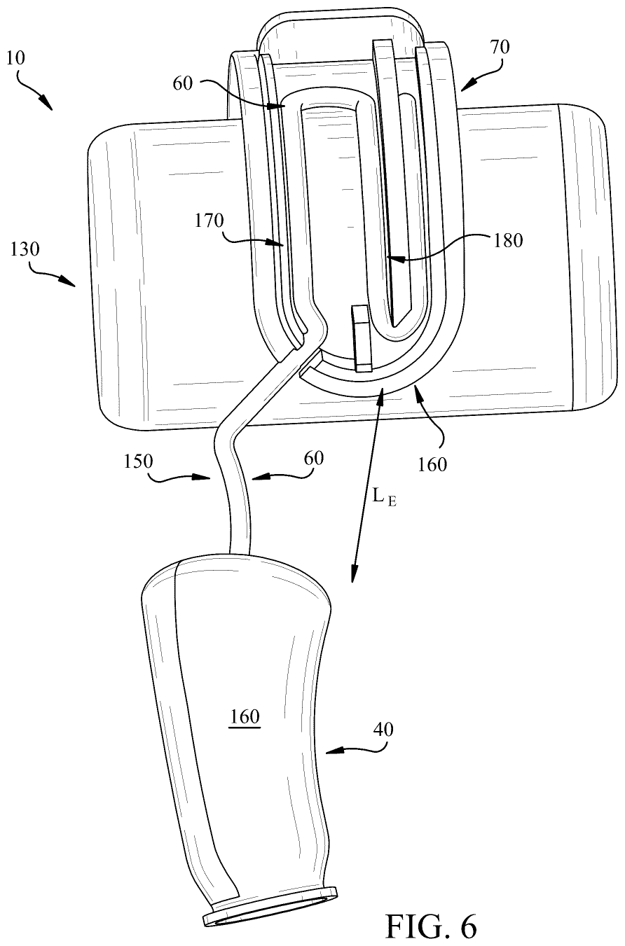

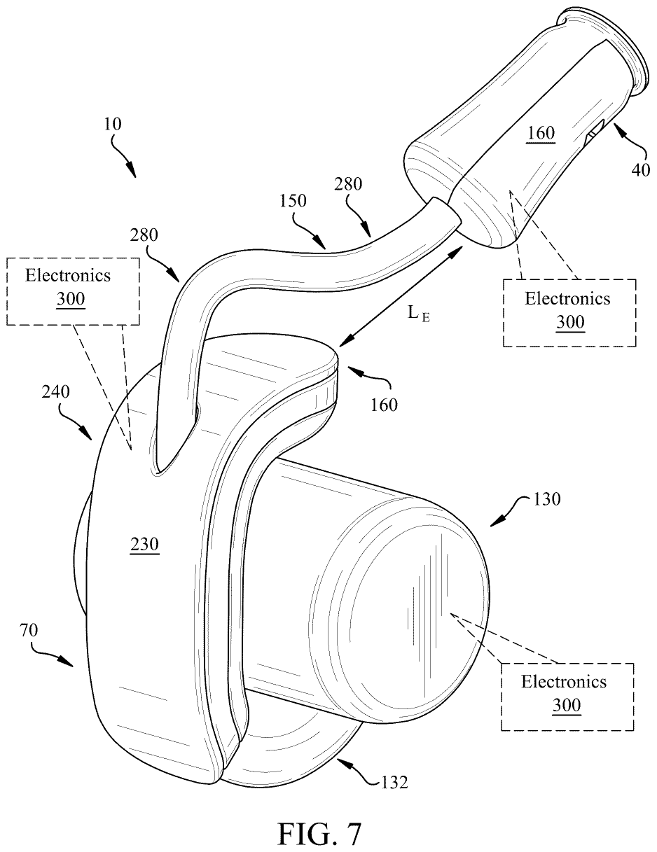

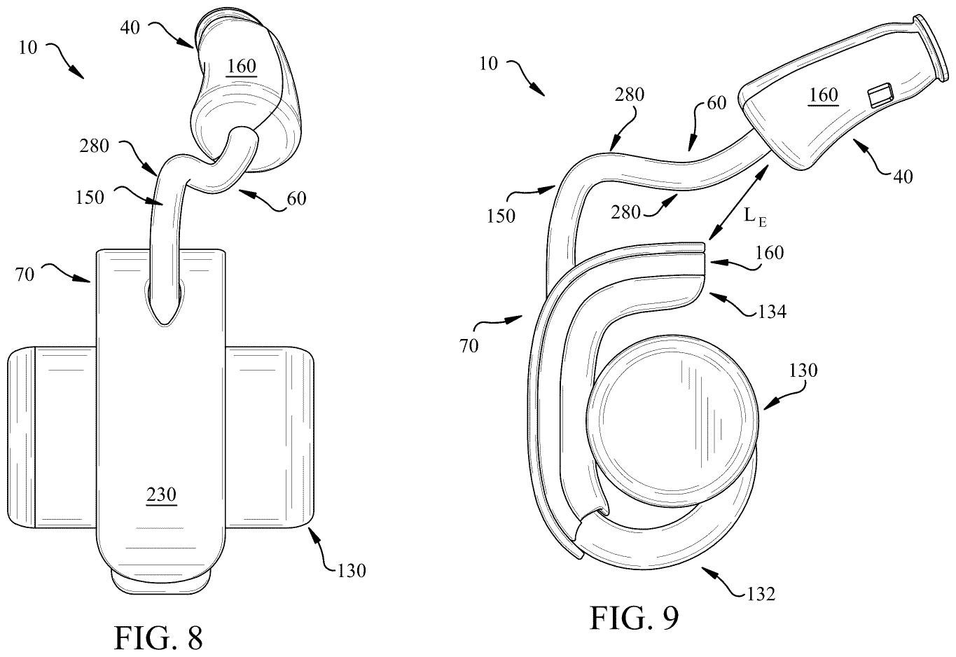

In some cases, as shown in more detail in FIG. 1, and the isolated view of the acoustic package 40 in FIGS. 4-6, the acoustic package 40 is housed in an ear tip 140. In some cases, the ear tip 140 provides an acoustic seal on the ear canal during use. In other cases, the ear tip 140 is non-occluding during use. In some aspects, the ear tip 140 is one of a plurality of ear tips of distinct size configured to accommodate distinct ear fits for the acoustic package 40. For example, ear tip 140 can be one of a set of ear tips of differing sizes (e.g., small, medium, large, extra-large, etc.) that are compatible with the outer dimension of the acoustic package 40. In some cases, e.g., as shown in FIG. 1, the ear tip 140 can include a separate component from a sleeve 150 that houses wiring 60. For example, the ear tip 140 can be removable and/or connectable separately from sleeve 150. In other cases, the sleeve 150 and ear tip 140 are connected (e.g., as a singular component) and are configured to be connected/disconnected from the wiring 60 collectively. In further implementations, the sleeve 150 is also removable separately from the ear tip 140. In some example depictions, FIG. 4 shows wiring 60 with a first type of sleeve 150 and without ear tip 140 on acoustic module 40, and FIGS. 5 and 6 show the wiring 60 and acoustic package 40 with a second type of sleeve 150 (e.g., thicker sleeve) and without ear tip 140. In other cases, e.g., in FIGS. 7-11, wiring 60 is shown with another distinct (e.g., thicker) sleeve 150 and without the ear tip 140 on the acoustic package 40. In still further implementations, the sleeve 150 and/or ear tip 140 are optional. For example, the acoustic package 40 can be configured for use without an ear tip 140 and/or the sleeve 150 can be configured for use without sleeve 150. In various implementations, the acoustic package 140 defines an earbud.

In particular aspects, the acoustic package 40 in the ear tip 140 comprises a driver having a diameter less than approximately 10 millimeters (mm), and in more particular cases, a diameter less than approximately 5 mm. In certain examples, such as where the headphone 10 is a hearing aid, the driver can have a diameter of approximately 5 mm or less. In other examples, such as where the headphone 10 is an earbud, the driver can have a diameter of approximately 10 mm or less.

In some cases, the acoustic package 40 includes a conventional receiver package for a receiver-in-canal (RIC) audio device, e.g., a RIC hearing assistance device (or, hearing aid) such as those described and depicted in U.S. patent application Ser. No. 18/537,981 (Acoustic Assembly Detection in Hearing Aid, filed Dec. 13, 2023) and Ser. No. 17/446,896 (“Hearing Assistance Devices and Methods of Generating a Resonance Within a Hearing Assistance Device” filed Sep. 3, 2021), and in U.S. Pat. No. 11,234,085 (“Earpieces and Related Articles and Devices” issued Jan. 25, 2022) each of which is entirely incorporated by reference herein.

For example, the acoustic package 40 can include at least one transducer (driver) and one or more microphones housed in a nozzle 160. In some cases, the nozzle 160 can include one or more contours, recesses, lips, etc., to interface with an ear tip (e.g., ear tip 140) and aid in retaining that ear tip during use of the audio device 10. In some implementations, the ear cuff body 30 houses additional circuitry, such as conventionally found in a behind-the-ear (BTE) portion of a RIC hearing assistance device as incorporated by reference herein. For example, the ear cuff body 30 can house a processor, a battery, one or more microphones, a communications module (e.g., a radio such as a BT radio), and memory (including instructions for controlling operations). As noted herein, one or more of the components or circuitry described as located in one portion of the audio device 10 can be located in another portion according to certain implementations.

The term “hearing assistance device” or “hearing aid” as used in this disclosure, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. A hearing assistance device includes an acoustic driver to transduce audio signals to acoustic energy. The acoustic driver can be housed in an earcup, earbud, or other portion of the hearing assistance device that sits within the user's ear canal during operation. While some of the figures and descriptions following can show a single hearing assistance device, a pair of hearing assistance devices can be provided, each having a respective portion that sits within the user's ear canal. Additionally, each hearing assistance device can be connected mechanically to another hearing assistance device or headphone, for example by a headband and/or by leads that conduct audio signals to an acoustic driver in the hearing assistance device or headphone. Further, as described herein, hearing assistance devices can include components for wirelessly receiving audio signals. A hearing assistance device can also include components of an active noise reduction (ANR) system. Hearing assistance devices can also include other functionality such as a microphone so that they can function as a headset.

While hearing assistance devices are described as one example implementation of the headphone 10, it is understood that headphone 10 can be intended for use as a conventional in-ear or on-ear audio device for, among other things, music playback, audio streaming, call audio, noise reduction (cancelation), etc., similar to the Bose Ultra Open Earbuds, the Bose QuietComfort Earbuds, or the Bose QuietComfort Ultra Earbuds, all available from Bose Corporation, Framingham, Massachusetts, USA.

Returning to FIGS. 1-3, and with additional reference for example to FIGS. 5-11, the sleeve 150 can be deformable to tailor a fit of the acoustic package 40 in the user's ear. For example, the sleeve 150 can include a thermoformed material that is configured to be deformed and retain its shape, e.g., including a bend, turn, kink, loop, etc. FIGS. 4-6 show examples of two relatively thinner sleeves 150. FIGS. 7-11 show a relatively thicker sleeve 150. In certain aspects, the sleeve 150 can be configured to prevent ingress of environmental debris such as dust, dirt, oils, etc., into the electronics in the ear cuff body 30, acoustic package 40, and/or wiring 60.

In some cases, the wiring 60 has an adjustable length to accommodate different fits. In other terms, the adjustable length refers to the effective length (L_{E}) of the wiring, for example, as measured between the exit location the wiring 60 from the ear cuff body 30 to the junction of the wiring 60 with the acoustic package 40. In other cases, the effective length (L_{E}) can be measured as the distance from a tip 160 of the first portion 70 to the junction of the wiring 60 and acoustic package 40. In particular cases, the adjustable length of the wiring 60 is configured to accommodate different ear dimensions, such as a distance from the user's ear canal to the antihelix or helix. In particular cases, the wiring 60 is at least partially housed in the ear cuff body 30, for example, in the first portion 70, as illustrated in FIG. 6. In one example, the wiring 60 is housed in a holder 170, e.g., a slot, recess, or cavity in the ear cuff body 30 (e.g., in first portion 70). In a particular example, the ear cuff body 30 includes a service loop 180 for storing a portion of the wiring 60, e.g., to aid in adjusting the effective length (L_{E}) of wiring 60 without placing undesirable strain on the wiring 60 during storage and/or use.

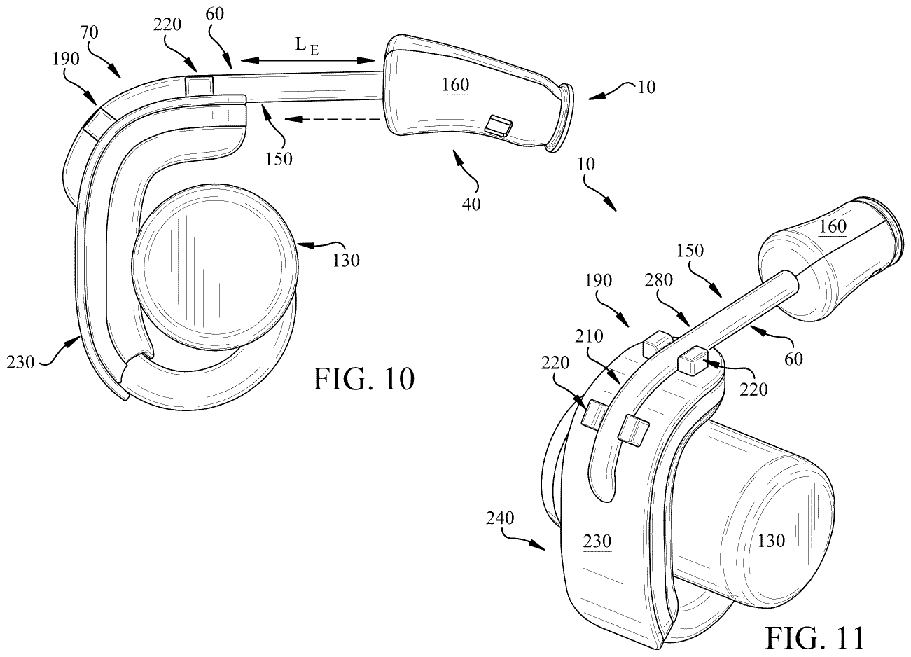

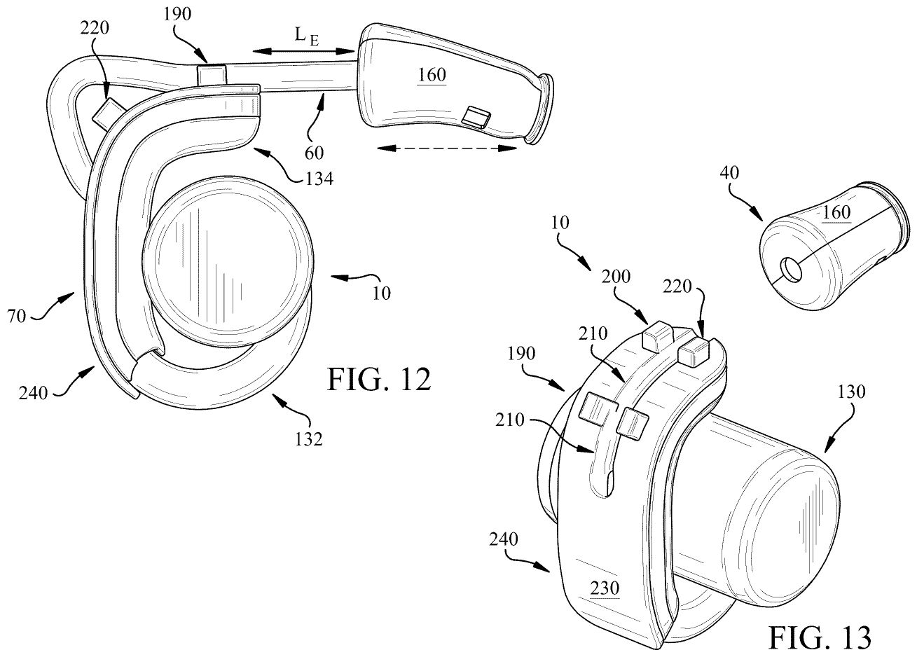

In some cases, as illustrated in FIGS. 10-13, the headphone 10 further includes at least one wire guide 190 coupled with the ear cuff body 30, for example, the first portion 70. In some cases, the wire guide 190 includes a wire management component 200 for controlling an effective distance between the ear cuff body 30 and the acoustic module 40 and/or for retaining a portion of the wiring 60. For example, the wire management component 200 can include at least one recess, clip, force-fit member, etc., that is configured to retain the wiring 60 relative to the ear cuff body 30. In one example depicted in FIGS. 10-13, the wire management component 200 includes a recess (or trough) 210 for guiding the wiring 60, and at least one clip 220 for retaining the wiring 60 relative to the outer surface 230 of the first portion 70. FIG. 13 shows the recess 210 and clip 220 in greater detail, with wiring removed 60. FIGS. 10 and 12 illustrate the contrast in effective length (L_{E}) between fully extended wiring 60 (FIG. 10) and wiring 60 that has been partially retracted and retained in the retracted position by wire management component 200 (e.g., clip 220). In some cases, the retracted wiring 60 is maintained outside of the body 240 of the first portion 70, as illustrated in FIG. 12. In other cases, the retracted wiring 60 can be tucked back into the body 240 of the first portion 70, e.g., and managed by a service loop 180 or similar feature (FIG. 6).

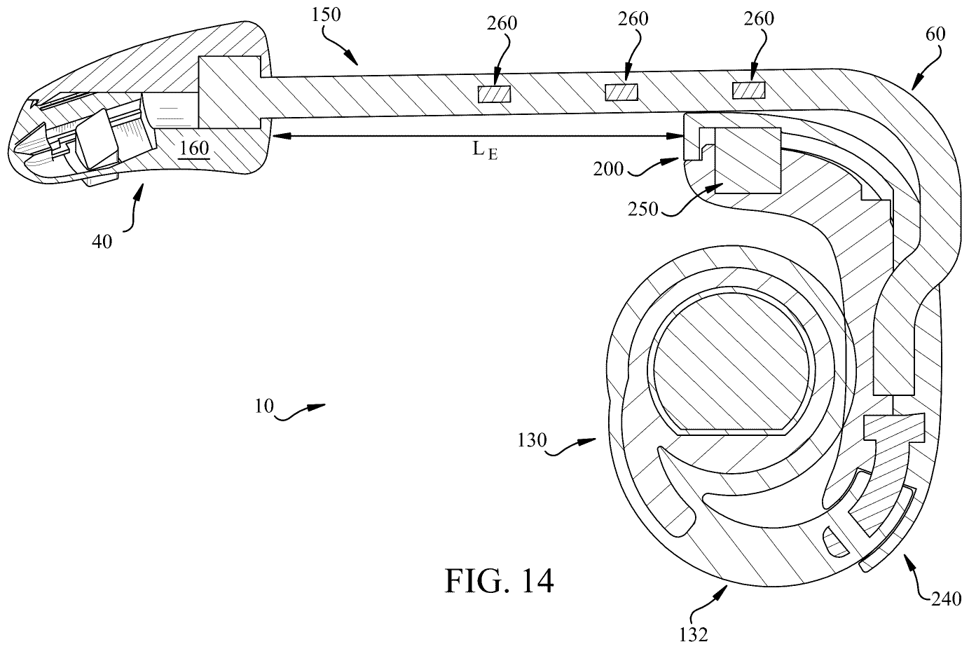

FIG. 14 illustrates an alternative wire management component 200, including at least one magnet 250 mounted in and/or on the body 240 of the first portion 70 that is configured to retain wiring 60 via one or more magnetic connectors (e.g., additional magnets or a magnetic material) 260 in and/or on the wiring 60. In this example, wiring 60 includes at least one magnetic connector 260 (e.g., one or more magnets, or a magnetic material) that is configured to be retained by an opposing magnet 250 mounted in and/or on the body 240 of the first portion 70. Similar to the use of clip 220 in the configurations in FIGS. 10-13, the magnets 250, 260 can allow the user to retract and extend the wiring 60 relative to the outer surface 230 of the first portion 70, thereby adjusting the effective length (L_{E}) between the first portion 70 and the acoustic module 40. Similarly to the configurations in FIGS. 10-13, the retracted wiring 60 can be maintained outside of the body 240 of the first portion 70, or tucked back into the body 240 of the first portion 70, e.g., and managed by a service loop 180 or similar feature (FIG. 6).

With reference for example to FIGS. 1 and 7-11, in still further implementations, wiring 60 can be modularly coupled with the acoustic module 40, such that the acoustic module 40 can be disconnected from wiring 60. In certain aspects, the wiring 60 is modularly coupled with the ear cuff body 30 (e.g., first portion 70) such that distinct lengths of wiring 60 can be coupled and decoupled with the ear cuff body 30 to accommodate distinct fits. In some of these cases, the wiring 60 is also modularly coupled with the acoustic module 40, meaning that the same acoustic module 40 can be coupled with the ear cuff body 30 via distinct lengths (or other types) of wiring 60.

In particular implementations, the wiring 60 includes a structural element providing a force on the acoustic package 40 to retain the acoustic package 40 in the ear canal region 50 (FIGS. 1-3). In certain examples, the structural element can include a protrusion for contacting a portion of the user's ear. Various types of structural element can be used to provide a force on the acoustic package, including for example, a thickened section 152 of a sleeve 150 around wiring 60 (e.g., FIG. 1). In some aspects, the thickened section 152 of the sleeve 150 is relatively thicker than another section of the sleeve 150. In other cases, the structural element can include a protrusion at one or more locations 280 along the wiring 60 for contacting a portion of the user's ear (example locations 280 shown in FIGS. 7-11). Examples of protrusions can include a wing, a pillar, a bump, etc.

As noted herein, the ear cuff body 30 and/or the acoustic package 40 can house various electronics 300 (including circuitry, sensors, audio components, communications components, power storage components, etc.) for providing headphone functions (illustrated in non-limiting examples in FIGS. 4, 5, and 7). In some cases, a portion of electronics 300 are housed in the ear cuff body 30, e.g., first portion 70 and/or second portion 130. In a particular implementation, at least one driver is located in the acoustic package 40 for delivering sound to the user's ear canal region 50. Electronics 300 can also include one or more microphones, which can be located in the ear cuff body 30 and/or acoustic package 40. In some cases, two or more microphones are present at distinct locations on the headphone 10, e.g., at distinct locations on first portion 70, or at locations on first portion 70, second portion 130, and/or acoustic package 40. In one example, a feedforward microphone is located on the ear cuff body 30, e.g., along the first portion 70 or the second portion 130. The feedforward microphone can be used, for example, in active noise reduction (ANR) and/or active noise cancelation (ANC) functions by the headphone 10. In further implementations, electronics 300 includes a power source such as a battery, which can be located in some examples in the ear cuff body 30. In a particular example, the battery is located in a battery barrel in the second portion 130 of the ear cuff body 30.

In various implementations, as noted herein, the ear cuff body 30 is generally “C” shaped when the headphone 10 is worn (e.g., as shown in FIGS. 2 and 3). As also illustrated in FIGS. 2 and 3, when the headphone 10 is worn, at least one of the antihelix, the helix, or the lobule of the ear is configured to be located between the first portion 70 of the ear cuff body 30 and the second portion 130 of the ear cuff body 30. In particular examples, a significant portion of the weight of the headphone 10 thus hangs from and is suspended from the cavum conchae; this holds the headphone 10 on the ear without the need for it to clamp to the ear. Further, as noted herein, the contact between the acoustic package 40 (e.g., including an eartip 140) and the user's ear canal region can provide additional support for the headphone 10 without the need to clamp to the user's ear.

As noted herein, the various disclosed headphones 10 can be configured for use as in-ear or on-ear audio devices. The headphones 10 can be configured to occlude a user's ear canal entrance in some cases. In other cases, the headphones 10 can provide a non-occluding fit.

As further noted herein, in some cases, the headphone 10 is part of a hearing aid, e.g., a RIC hearing aid. In such cases, the acoustic package 40 (e.g., with or without eartip 140) can be configured to seal an entrance of the user's ear canal region (e.g., the ear canal entrance) 50.

As noted herein, various implementations of headphone 10 can beneficially enhance the user experience by, among other things, enhancing fit, sealing and/or acoustic performance relative to conventional open-ear headphones and/or in-ear headphones (or, earbuds). For example, relative to open-ear headphones, the headphone 10 can enhance audio clarity, decrease unwanted bleed-through sound (e.g., via occlusion), and enable ANR functionality via sealing of the user's ear canal and inclusion of one or more feedback microphones. Further, relative to conventional open-ear headphones, headphone 10 can provide additional contact surfaces with the user's ear (e.g., via acoustic package 40, with or without eartip 140), improving stability and fit. Further, relative to conventional earbuds, the headphone 10 can distribute the weight of electronics across the user's ear, e.g., across the outer side of the anti-helix, helix, and/or lobule of the outer ear, improving comfort. Additionally, the ear cuff 20 can allow for improved stability and fit relative to conventional earbuds. The enhanced stability and/or fit can also enhance acoustic performance, enabling beneficial positioning of the acoustic package 40 relative to the ear canal entrance, along with beneficial sealing of the ear canal entrance in occluding configurations. Further, the fit-based benefits described herein can enhance usage by a plurality of users with distinct ear shapes, sizes, etc. The headphone 10 can be adaptable to a plurality of distinct users'ear shapes, sizes, etc., via modularity and/or adjustability of components, in addition to enhanced stability as described herein. Additionally, as noted herein, the headphone 10 can provide a visually appealing form factor for use as an earbud, hearing aid, etc. In particular examples, such as where the headphone 10 includes a hearing aid, the ear cuff form factor may provide a more visually appealing design to users compared with conventional hearing aids. Further, some example implementations of the ear cuff include a prominent display surface (e.g., outer surface 230) that can be customized and/or decorated in various implementations to provide visual benefits comparable to jewelry.

The systems and methods disclosed herein may include or operate in, in some examples, headsets, headphones, hearing aids, or other personal audio devices, as well as acoustic noise reduction systems that may be applied additional audio systems. Throughout this disclosure the terms “headset,” “headphone,” “earphone,” and “headphone set” are used interchangeably, and no distinction is meant to be made by the use of one term over another unless the context clearly indicates otherwise. Additionally, aspects and examples in accord with those disclosed herein are applicable to various form factors, such as in-ear transducers or earbuds and on-ear or over-ear headphones, and others.

Examples disclosed may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

For various components described herein, a designation of “a” or “b” in the reference numeral may be used to indicate “right” or “left” versions of one or more components. When no such designation is included, the description is without regard to the right or left and is equally applicable to either of the right or left, which is generally the case for the various examples described herein. Additionally, aspects and examples described herein are equally applicable to monaural or single-sided personal acoustic devices and do not necessarily require both of a right and left side.

Examples of the headphones described herein are not limited in application to the details of construction and the arrangement of components set forth in the following description or illustrated in the accompanying drawings. The headphones are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing.

Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. A headphone comprising:
an ear cuff body having:
a first portion configured to pass over an outer side of at least one of an antihelix, a helix, or a lobule of a user's outer ear; and
a second portion configured to sit behind the outer ear;
an acoustic package configured to deliver sound to the ear canal region; and
wiring extending between the ear cuff body to the acoustic package.

2. The headphone of claim 1, wherein the acoustic package is housed in an ear tip.

3. The headphone of claim 2, wherein the ear tip provides an acoustic seal on the ear canal during use.

4. The headphone of claim 2, wherein the ear tip is non-occluding during use.

5. The headphone of claim 2, wherein the ear tip is one of a plurality of ear tips of distinct size configured to accommodate distinct ear fits for the acoustic package.

6. The headphone of claim 2, wherein the acoustic package comprises a driver having a diameter less than approximately 10 millimeters (mm).

7. The headphone of claim 1, wherein the wiring is housed in a sleeve.

8. The headphone of claim 7, wherein the sleeve is deformable to tailor a fit of the acoustic package in the user's ear.

9. The headphone of claim 7, wherein the sleeve includes a thermoformed material.

10. The headphone of claim 1, wherein the wiring has an adjustable length to accommodate different fits.

11. The headphone of claim 1, wherein the wiring is at least partially housed in the ear cuff body.

12. The headphone of claim 11, and wherein the ear cuff body includes a service loop for storing a portion of the wiring.

13. The headphone of claim 11, further comprising at least one wire guide coupled with the ear cuff body.

14. The headphone of claim 1, wherein the wiring is modularly coupled with the ear cuff body such that distinct lengths of wiring can be coupled and decoupled with the ear cuff body to accommodate distinct fits.

15. The headphone of claim 1, wherein the wiring is modularly coupled with the acoustic module.

16. The headphone of claim 1, wherein the wiring includes a structural element providing a force on the acoustic package to retain the acoustic package in the ear canal region.

17. The headphone of claim 16, wherein the structural element includes at least one of: a protrusion for contacting a portion of the user's ear, or a thickened section of a sleeve around a portion of the wiring.

18. The headphone of claim 1, further comprising a driver for delivering the sound via the acoustic package, wherein the driver is located in the ear cuff body or in the acoustic package.

19. The headphone of claim 1, further comprising at least one microphone located in the ear cuff body and/or the acoustic package.

20. The headphone of claim 19, wherein the at least one microphone comprises at least two microphones at distinct locations on the headphone, one of which includes a feedforward microphone located on the ear cuff body.

21. The headphone of claim 1, wherein at least one of the antihelix, the helix, or the lobule of the ear is configured to be located between the first portion of the ear cuff body and the second portion of the ear cuff body, wherein the ear cuff body is generally “C” shaped.

22. The headphone of claim 1, further comprising a battery module contained in the ear cuff body, wherein the battery module is housed in the second portion of the body.

23. The headphone of claim 1, wherein the acoustic package defines an earbud.

24. A receiver-in-canal (RIC) hearing aid comprising the headphone of claim 1, wherein the acoustic package is configured to seal an entrance to the user's ear canal.
